(19) United States
(12) Patent Application Publication
(10) Pub. No.: US 2024/0105106 A1
(43) Pub. Date: Mar. 28, 2024

(54) PIXEL COMPENSATION CIRCUIT, DRIVING METHOD THEREOF AND ELECTROLUMINESCENT DISPLAY

(71) Applicant: ULTRADISPLAY INC., Zhubei City (TW)

(72) Inventor: Shih-Song CHENG, Zhubei City (TW)

(73) Assignee: ULTRADISPLAY INC., Zhubei City (TW)

(21) Appl. No.: 18/230,532

(22) Filed: Aug. 4, 2023

(30) Foreign Application Priority Data
Sep. 28, 2022 (TW) 111136707

(51) Int. Cl. G09G 3/32

(52) U.S. Cl. CPC G09G 3/32; G09G 2300/0852; G09G 2310/027

(57) ABSTRACT

Embodiments of the present application provide a pixel compensation circuit, a driving method thereof, and an electroluminescent display. The pixel compensation circuit includes a grayscale converter and a current generator, and the grayscale converter is configured to receive a first data voltage and a second data voltage, establish a compensation voltage in a first time period, and change the compensation voltage into the grayscale voltage in a second time period. The current generator is configured to pass a driving current to the electroluminescent element in response to the grayscale voltage so as to drive the electroluminescent element to emit light with a main grayscale or a sub-grayscale. In this way, the high bit depth can be achieved, the real grayscale of the pixel can be presented, the problem of grayscale confusion caused by a small data range can be solved, and the picture quality of the display can be improved.

### CROSS-REFERENCE TO RELATED DISCLOSURES

This disclosure claims priority to Taiwan Patent Disclosure No. 11136707, filed on Sep. 28, 2022, entitled “Pixel compensation circuit, driving method thereof and electroluminescent display”, which is hereby incorporated by reference in its entirety.

### TECHNICAL FIELD

The present disclosure relates to a field of pixel compensation circuits, in particular to a pixel compensation circuit for an electroluminescent display.

### BACKGROUND

An electroluminescence display uses light Emitting Diode (LED) or Organic Light Emitting Diode (OLED) as a light-emitting device, and is widely used in consumer and industrial fields nowadays. The improving of display quality is an important and continuous target in developing display technique. No matter the driving substrate of a display uses the Thin Film Transistor (TFT) process used in a traditional display or the CMOS (Complementary Metal-Oxide-Semiconductor) process used in a micro display, a very strict requirement is applied on the photoelectric conversion accuracy, and a precise definition on grayscale determines the display quality.

In such displays, the data precision of grayscale is usually set by using a driving method in an analog way. Such data precision is a ratio of bit depth (or grayscale depth) to data range, and thus it is necessary for the pixel circuit to be operated in a larger data range, if the bit depth is to be increased while the data precision is kept the same. However, such method is limited by the performance of the device made in the process, and when the bit depth that the hardware architecture can achieve is fixed, the driver cannot perform switch for more grayscales in a fixed data range, which often renders grayscale mixed and the quality it can present is degraded.

### BRIEF SUMMARY

Aspects of the present disclosure provide a pixel compensation circuit, a driving method thereof and an electroluminescent display, which may perform switch among various grayscale in a small data range and the display quality is improved.

An embodiment of the present disclosure provides a pixel compensation circuit including an electroluminescent element, a grayscale converter, and a current generator. The grayscale converter is coupled to a first node and at least one data terminal, and configured to receive a first data voltage and a second data voltage, establish a compensation voltage at the first node in a first time period, and change the compensation voltage to a grayscale voltage according to the first data voltage and the second data voltage in a second time period. The grayscale voltage includes a main grayscale voltage corresponding to the first data voltage and a sub-grayscale voltage synthesizing the first data voltage and the second data voltage. The current generator is coupled to the first node and the grayscale converter, and configured to pass a driving current in response to the grayscale voltage and transmit the driving current to the electroluminescent element in response to a light signal, so as to drive the electroluminescent element to emit light with a grayscale. The grayscale includes a main grayscale corresponding to the grayscale voltage and a sub-grayscale, and the sub-grayscale is one of a plurality of sub-grayscales between the main grayscale and a previous grayscale of the main grayscale and between the main grayscale and a next grayscale of the main grayscale.

In one embodiment of the present disclosure, the current generator includes a driving transistor and a switching transistor, two opposite terminals of the driving transistor are respectively coupled to a first power supply and the switching transistor, and a gate of the driving transistor is coupled to the first node and configured to be turned on in response to the grayscale voltage, so as to pass the driving current to the switching transistor. Two opposite terminals of the switching transistor are respectively coupled to the driving transistor and the electroluminescent element, and a gate of the switching transistor is coupled to a light signal end and configured to be turned on in response to a light signal so as to pass the driving current to the electroluminescent element.

In one embodiment of the present disclosure, the grayscale converter includes a compensation circuit. A compensation transistor of the compensation circuit is coupled to the driving transistor, the switch transistor, and the first node, and configured to be turned on in response to a second control signal, and correspondingly establish the compensation voltage at the first node.

In one embodiment of the present disclosure, the grayscale converter further includes a converting circuit configured to establish the first data voltage at a third node and the second data voltage at a second node in response to the second control signal.

In one embodiment of the present disclosure, the converting circuit includes a first capacitor and a second capacitor, respectively configured to store the compensation voltage in the first time period and change the compensation voltage in the second time period. One terminal of the first capacitor is coupled to the first node, and the other terminal of the first capacitor is coupled to the first power supply or the third node. One terminal of the second capacitor is coupled to the first node, and the other terminal of the second capacitor is coupled to the second node.

In one embodiment of the present disclosure, two opposite terminals of the first capacitor are coupled to the first node and the first power supply, the compensation transistor is turned on in response to the second control signal and transmits the first data voltage to the first node. The compensation voltage is a voltage difference between the first data voltage and a threshold voltage of the driving transistor.

In one embodiment of the present disclosure, the converting circuit further includes: a first transistor, respectively coupled to a reference voltage end and the first node, and configured to transmit a reference voltage to the first node in response to a first control signal as an initialization voltage of the driving transistor; a second transistor, respectively coupled to a first data end and the third node, and configured to transmit the first data voltage to the third node in response to the second control signal; a third transistor, respectively coupled to a second data end and the second node, and configured to transmit the second data voltage to the second node in response to the second control signal; a fourth transistor, respectively coupled to the first power supply and the second node, and configured to transmit the first power supply voltage to the second node in response to a third control signal, and generate a second data voltage difference between the second node and the second data voltage; a fifth transistor, respectively coupled to the first power and the third node, and configured to transmit the first power supply voltage to the third node in response to the third control signal. The third node is coupled to the second transistor, the fifth transistor and the driving transistor.

In one embodiment of the present disclosure, two opposite terminals of the first capacitor are coupled to the first node and the third node. The compensation transistor is turned on in response to the second control signal and receives and transmits a first power supply voltage to the first node. The compensation voltage is a voltage difference between the first power supply voltage and a threshold voltage of the driving transistor.

In one embodiment of the present disclosure, the converting circuit further includes: a first transistor, respectively coupled to a ground terminal and the first node, and configured to transmit a ground voltage to the first node in response to a first control signal as an initialization voltage of the first capacitor; a second transistor, respectively coupled to the first power supply and the third node, and configured to transmit a first power supply voltage to the third node in response to the first control signal; a third transistor, respectively coupled to a first data terminal and the third node, and configured to transmit the first data voltage to the third node in response to the second control signal; a fourth transistor, respectively coupled to a second data end and the second node, and configured to transmit the second data voltage to the second node in response to the second control signal; a fifth transistor, respectively coupled to a reference voltage end and the third node, and configured to transmit a reference voltage to the third node in response to a third control signal and generate a first data voltage difference between the first data voltage and the reference voltage at the third node; a sixth transistor, respectively coupled to the reference voltage end and the second node, and configured to transmit the reference voltage to the second node in response to the third control signal and generate a second data voltage difference between the second node and the second data voltage.

Embodiments of the present disclosure provide an electroluminescence display, including: an array of pixel cells. Each pixel cell includes the pixel compensation circuit as described above.

Embodiments of the present disclosure provide a driving method for driving a pixel compensation circuit, including: applying a second control signal to the grayscale converter, receiving and transmitting a first data voltage to a third node and a second data voltage to a second node, and establishing a compensation voltage at a first node; storing the compensation voltage in a first capacitor and a second capacitor of the grayscale converter; applying a third control signal to the grayscale converter to correspondingly generate a second data voltage difference between the second node and the second data voltage; changing, by the second capacitor, the compensation voltage according to the second data voltage difference and correspondingly generating a grayscale voltage, wherein the grayscale voltage includes the compensation voltage and a second data division voltage of the second data voltage difference, and the second data division voltage is related to a ratio of a capacitance of the first capacitor to a capacitance of the second capacitor; and applying the grayscale voltage to a current generator, passing a driving current corresponding to the grayscale voltage to an electroluminescent element, so that the electroluminescent element emits light with a grayscale, wherein the grayscale includes a main grayscale and a sub-grayscale, and the sub-grayscale is one of a plurality of sub-grayscales between the main grayscale and a previous grayscale of the main grayscale and between the main grayscale and a next grayscale of the main grayscale.

In one embodiment of the present disclosure, the step of applying a second control signal to the grayscale converter further includes: receiving and transmitting, by a converting circuit of the grayscale converter, the first data voltage to the third node and the second data voltage to the second node in response to the second control signal; and establishing, by a compensation circuit of the grayscale converter, the compensation voltage at the first node in response to the second control signal.

In one embodiment of the present disclosure, the step of applying a third control signal to the grayscale converter further includes: receiving and transmitting, by the converting circuit, a first power supply voltage or a reference voltage to the second node in response to the third control signal, and generating the second data voltage difference between the first power supply voltage or the reference voltage and the second data voltage.

In one embodiment of the present disclosure, the driving method further includes: generating, by the switching circuit, a first data voltage difference at the third node in response to the third control signal; and changing, by the first capacitor, the compensation voltage according to the first data voltage difference synchronously to generate the grayscale voltage. The grayscale voltage includes the compensation voltage, the second data division voltage, and a first data division voltage of the first data voltage difference, and the first data division voltage is related to a ratio of a capacitance of the first capacitor to a capacitance of the second capacitor.

In one embodiment of the present disclosure, the step of applying the grayscale voltage to a current generator further includes: applying the grayscale voltage to a driving transistor of the current generator and passing the driving current to a switching transistor of the current generator; and applying a light signal to the switching transistor to pass the driving current to the electroluminescent element.

In one embodiment of the present disclosure, before the step of applying a second control signal to the grayscale converter, the driving method further includes: applying a first control signal to the grayscale converter, passing a reference voltage to the first node, and initializing a gate of the driving transistor; or passing a ground voltage to the first node to initialize the gate of the driving transistor, and passing a first power supply voltage to the third node to initialize one terminal of the first capacitor. Two opposite terminals of the first capacitor are coupled to the first node and the third node, respectively.

The pixel circuit provided in the embodiment of the present disclosure is configured to receive a first data voltage and a second data voltage, and the pixel compensation circuit establishes a compensation voltage in a first time period, and adjusts the compensation voltage by using the first data voltage and the second data voltage in a second time period. Furthermore, each main grayscale voltage may be further divided into more finer sub-grayscale voltage, so that the electroluminescent element may emit light with a corresponding main grayscale or a sub-grayscale. Therefore, in this way, the grayscale that can be presented by the electroluminescent element may be set in a more subtle precision, so as to achieve a presentation close to the real grayscale. Therefore, the grayscale confusion caused by too small data interval can be improved, and the picture quality of the display can be specifically improved.

### BRIEF DESCRIPTION OF THE DRAWINGS

The drawings described herein are intended to provide a further understanding of the present disclosure, and are incorporated in and constitute a part of this specification, schematic embodiments of the disclosure and together with the description serve to explain the principles of the present disclosure, and do not constitute an improper limitation of the present disclosure. It should be noted that, in accordance with standard practice in the art, the features in the diagram are not drawn to scale. In fact, the dimensions of certain features may be deliberately enlarged or reduced for clear description. In the drawings:

FIG. 1 is a block diagram of the pixel compensation circuit according to an embodiment of the present disclosure.

FIG. 2 is a schematic diagram of the main grayscale and the sub-grayscale according to an embodiment of the present disclosure.

FIG. 3 is a circuit diagram of a pixel compensation circuit according to an embodiment of the present disclosure.

FIG. 4a is an operation timing diagram of the pixel compensation circuit according to the embodiment shown in FIG. 3 at time t1.

FIG. 4b is a schematic diagram of the operation of the pixel compensation circuit according to the embodiment shown in FIG. 3 at time t1 shown in FIG. 4a.

FIG. 5a is an operation timing diagram of the pixel compensation circuit according to the embodiment shown in FIG. 3 at time t2.

FIG. 5b is a schematic diagram of the operation of the pixel compensation circuit according to the embodiment shown in FIG. 3 at time t2 shown in FIG. 5a.

FIG. 6a is an operation timing diagram of the pixel compensation circuit according to the embodiment shown in FIG. 3 at time t3.

FIG. 6b is a schematic diagram of the operation of the pixel compensation circuit according to the embodiment shown in FIG. 3 at time t3 shown in FIG. 6a.

FIG. 7a is an operation timing diagram of the pixel compensation circuit according to the embodiment shown in FIG. 3 at time t4.

FIG. 7b is a schematic diagram of the operation of the pixel compensation circuit according to the embodiment shown in FIG. 3 at time t4 shown in FIG. 7a.

FIG. 8 is a flowchart of a driving method of driving the pixel compensation circuit according to the embodiment of FIG. 3.

FIG. 9 is a circuit diagram of a pixel compensation circuit according to another embodiment of the present disclosure.

FIG. 10a is an operation timing diagram of the pixel compensation circuit according to the embodiment shown in FIG. 9 at time t1.

FIG. 10b is a schematic diagram of the operation of the pixel compensation circuit according to the embodiment shown in FIG. 9 at time t1 shown in FIG. 10a.

FIG. 11a is an operation timing diagram of the pixel compensation circuit according to the embodiment shown in FIG. 9 at time t2.

FIG. 11b is a schematic diagram of the operation of the pixel compensation circuit according to the embodiment shown in FIG. 9 at time t2 shown in FIG. 11a.

FIG. 12a is an operation timing diagram of the pixel compensation circuit according to the embodiment shown in FIG. 9 at time t3.

FIG. 12b is a schematic diagram of the operation of the pixel compensation circuit according to the embodiment shown in FIG. 9 at time t3 shown in FIG. 12a.

FIG. 13a is an operation timing diagram of the pixel compensation circuit according to the embodiment shown in FIG. 9 at time t4.

FIG. 13b is a schematic diagram of the operation of the pixel compensation circuit according to the embodiment shown in FIG. 9 at time t4 shown in FIG. 13a.

### DETAILED DESCRIPTION

Hereinafter, the present disclosure will be described in detail with reference to the accompanying drawings along with illustrated embodiments, so as to better clarify the object, technical solution and advantageous of the present disclosure. It can be conceivable that such descriptions are merely exemplary and are not intended to limit the present disclosure.

Transistors used in all embodiments of the present disclosure may be thin-film transistors or field-effect transistors (FET) or other devices with the same characteristics, e.g., metal-oxide-semiconductor (MOS) transistors. Meanwhile, in order to distinguish the two electrodes of the transistor other than the gate electrode (Gate), one of the two electrodes may be referred as the first electrode, and the other electrode may be referred as the second electrode. One skilled in the art would understand that the drain and source of the transistor are interchangeable, depending on the voltage level applied thereto. Therefore, in practical operations, the first electrode may be the drain electrode, and the second electrode may be the source electrode; alternatively, the first electrode may be the source electrode, and the second electrode may be the drain electrode.

Further, it should be understood that if one component is described as being “connected to” or “coupled to” another component, these two components may be directly connected or coupled to each other, or there may be other intervening component therebetween. Further, when a device is of the type of positive edge trigger (active high), a signal is asserted to a high logical level to start the device. Conversely, the signal is deasserted to a low logical level to deactivate the device. However, when a device is of the type of negative edge trigger (active low), a signal is deasserted to a low logical level to start the device, and it is asserted to a high logical level to deactivate the device.

In addition, the expressions of first, second, etc. added before some constituent elements in the embodiments of the present application are only for the convenience of description and understanding of the contents of the embodiments of the present application, and are not used to indicate the number or order of the constituent elements.

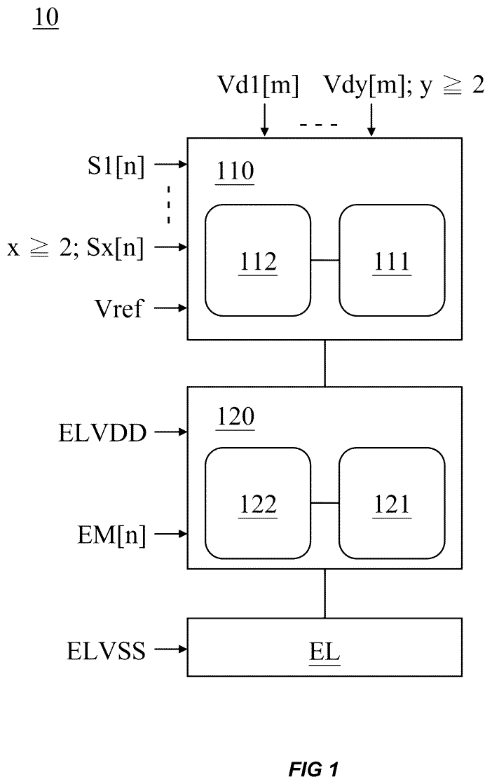

Reference now may be made to FIG. 1. Embodiments of the present disclosure provide a pixel compensation circuit 10 applicable to be used in a pixel unit array of an electroluminescent display, to drive an electroluminescent element EL to emit light, and to adjust the grayscale conversion of the electroluminescent element EL. The electroluminescent display includes a display panel, a gate driver, a source driver, and a power driver. The display panel is provided with a plurality of pixels arranged in a matrix, and the pixels are arranged in a manner of N rows*M columns, N and M are natural numbers respectively.

The gate driver supplies a control signal and a light signal to the pixels of the n^{th} row via control signal terminals S1[n] to Sx[n] (1≤n≤N, X≥2) and light signal terminal EM[n] of the N signal lines, respectively. The source driver provides a data voltage to a selected pixel in the m^{th} row of pixels through data voltage terminals Vd1[m], Vdy[m] (1≤m≤M, y≥2) of the M data lines. The power driver provides a first power supply voltage ELVDD and a second power supply voltage ELVSS to a display area. In addition, a DC bias source provides a reference voltage Vref to the display area. In one embodiment, the first power supply voltage ELVDD is about 5 volts (5V), the second power supply voltage ELVSS is about −5V, and the reference voltage Vref is about 2.5V.

The pixel compensation circuit 10 includes a grayscale converter 110, a current generator 120, and an electroluminescent element EL. The grayscale converter 110 is coupled to a first node and at least one data terminal, and is configured to receive a first data voltage and a second data voltage, establish a compensation voltage at that first node in a first time period, and change the compensation voltage into a grayscale voltage according to the first data voltage and the second data voltage in a second time period. The grayscale voltage includes a main grayscale voltage corresponding to the first data voltage and a sub-grayscale voltage synthesizing the first data voltage and the second data voltage.

In an embodiment of the present application, the grayscale converter 110 includes a compensation circuit 111 and a converting circuit 112. The compensation circuit 111 is coupled between the converting circuit 112 and the current generator 120. And the compensation circuit is couple to the signal ends S1[n] to Sx[n] and is configured to establish the compensation voltage at the first node in response to a second control signal. The converting circuit 111 is coupled to the signal terminals S1[n] to Sx[n], the data voltage terminals Vd1[m] to Vdy[m], the reference voltage terminal and a first power supply, and is configured to receive a first data voltage and a second data voltage in response to a second control signal, and change the compensation voltage into the grayscale voltage in response to a third control signal.

The current generator 120 is coupled to the first node and the grayscale converter 110, and configured to pass a driving current in response to the grayscale voltage and transmit the driving current to the electroluminescent element in response to a light signal, so that the electroluminescent element is driven by the driving current to emit light with a grayscale.

In an embodiment of the present application, the current generator 120 includes a driving circuit 121 and a switching circuit 122. The driving circuit 121 is coupled to the switching circuit 122 and the first power supply and configured to pass the driving current to the switching circuit 122 in response to the grayscale voltage of the first node. The switching circuit 122 is coupled between the driving circuit 121 and the electroluminescent element EL, and the electroluminescent element EL is coupled to the second power supply.

In addition, the switching circuit 122 is further coupled to the light signal end EM[n] for passing the driving current to the electroluminescent element EL in response to a light signal, so that the electroluminescent element EL emits light with a grayscale. The grayscale includes a main grayscale corresponding to the grayscale voltage and a sub-grayscale, and the sub-grayscale is one of a plurality of sub-grayscales between the main grayscale and a previous grayscale of the main grayscale and between the main grayscale and a next grayscale of the main grayscale.

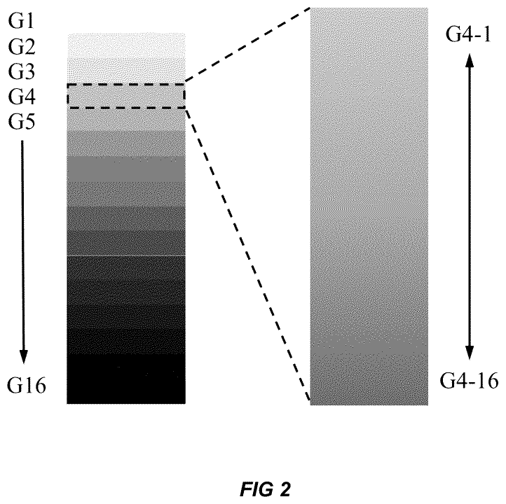

For example, in a grayscale mode with a bit depth of 4 bits, an image has 24, i.e., 16, possible grayscale values (as shown in FIG. 2). In one frame time, one of the 16 grayscales G1-G16 may be used as the main grayscale of the electroluminescent element EL, for example, the electroluminescent element EL emits light with a grayscale of G4 to show a first grayscale image.

Alternatively, with adjustment to the second data voltage in the same frame time, a sub-grayscale of the grayscale G4 itself may be selected as the second grayscale to drive the electroluminescent element EL to emit light. That is, with the hardware architecture unchanged, there are 16 possible sub-grayscales G4-1 to G4-16 between a previous grayscale G3 and a next grayscale G5 with respect to the grayscale G4. And one of the 16 sub-grayscales G4-1 to G4-16 may be used as a second grayscale to drive the electroluminescent element EL to emit light so as to present a second grayscale image which is closer to a real image.

Similarly, in some embodiments of the present disclosure, when the bit depth is 8 bits, an image may have 28, i.e., 256, possible main grayscales, and each main grayscale has 28, i.e., 256, possible sub-grayscales between a previous grayscale and a next grayscale with respect to this main grayscale, so that the electroluminescent device EL may emit light with the main grayscale or sub-grayscales.

As shown in the table below. It should be noted that, in the pixel compensation circuit 10 provided by the embodiment of the present application, the grayscale converter 110 may be coupled to one or more first data ends Vd1[m] and one or more second data ends Vd2[m], and the first data terminals and the second data terminals may be configured in a one-to-many, many-to-one, or many-to-many manner.

Therefore, the number of the grayscale voltages received by the grayscale converting circuit is multiplied, and more main grayscales and sub-grayscales can be obtained by performing dividing in the subsequent operation.

| | |
|---|---|
| Number of configurable data ends | Number of output |

| Vd1[m] | Vd2[m] | grayscale voltages |
|---|---|---|
| 1 | 1 | 1 * (1 + 1) = 2 |
| | 2 | 1 * (2 + 1) = 3 |
| | Q | 1 * (Q + 1) = Q + 1 |
| 2 | 1 | 2 * (1 + 1) = 4 |
| | 2 | 2 * (2 + 1) = 6 |
| | Q | 2 * (Q + 1) = 2(Q + 1) |
| 3 | 1 | 3 * (1 + 1) = 6 |
| | 2 | 3 * (2 + 1) = 9 |
| | Q | 3 * (Q + 1) = 3(Q + 1) |
| P | Q | P * (Q + 1) = P(Q + 1) |

P is a natural number greater than 1 and Q is a natural number greater than 1.

Therefore, in such adjusting mode that the main grayscale is used with the sub-grayscale, with the hardware architecture of the electroluminescence display unchanged, the compensation voltage may be adjusted by the first data voltage and the second data voltage to obtain a grayscale voltage so as to perform fine adjustment operation to increase or decrease corresponding main grayscale value, and thus a finer picture can be presented, and the problem of grayscale confusion can be solved

The pixel compensation circuit 10 of the present application is further described below with some specific embodiments.

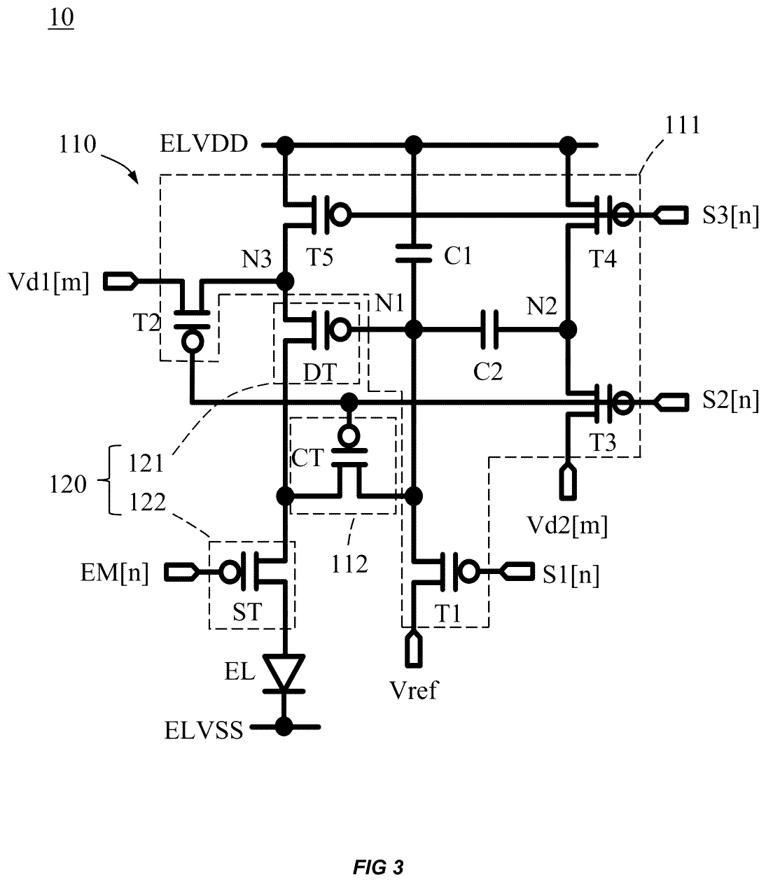

Reference now may be made to FIG. 3. In some embodiments of the present disclosure, the converting circuit 111 of the grayscale converter 110 includes a first capacitor C1, a second capacitor C2, and first transistor T1 to fifth transistor T5. One terminal of the first capacitor C1 is coupled to the first node N1, and the other terminal of the first capacitor C1 is coupled to the first power supply (first power supply voltage end). The second capacitor C2 has one terminal coupled to the first node N1 and the other terminal coupled to the second node N2.

The first transistor T1 has a gate coupled to a first control signal end S1[n] for responding to a first control signal, a first terminal coupled to the first node N1, and a second terminal coupled to the reference voltage end for receiving the reference voltage Vref. The second transistor T2 has a gate coupled to a second control signal end S2[n] for responding to a second control signal, a first terminal coupled to a third node N3 between the fifth transistor T5 and the current generator 120, and a second terminal coupled to a first data line Vd1[m] for receiving the first data voltage. The third transistor T3 has a gate coupled to a second signal line S2[n] for responding to the second control signal, a first terminal coupled to the second node, and a second terminal coupled to a second data line Vd2[m] for receiving the second data voltage. The fourth transistor T4 has a gate coupled to a third signal line S3[n] for responding to a third control signal, a first terminal coupled to the first power supply, and a second terminal coupled to the second node N2. The fifth transistor T5 has a gate coupled to a third signal line S3[n] for responding to the third control signal, a first terminal coupled to the first power supply, and a second terminal coupled to a third node N3.

The compensation circuit 112 of the grayscale converter 110 includes a compensation transistor CT having a gate coupled to the second signal line S2[n] for responding to the second control signal, a first terminal coupled between the driving circuit 121 of the current generator 120 and the switching circuit 122, and a second terminal coupled to the first node N1.

Furthermore, the driving circuit 121 of the current generator 120 includes a driving transistor DT having a gate coupled to the first node N1, a first terminal coupled to the third node N3, and a second terminal coupled to the compensation transistor CT and the switching circuit 122. The switching circuit 122 of the current generator 120 includes a switching transistor ST having a gate coupled to the light signal end EM[n] for responding to a light signal, a first terminal coupled to the second terminal of the driving transistor DT, and a second terminal coupled to an anode of the electroluminescent element EL. A cathode of the electroluminescent element EL is coupled to a second power supply (second power supply voltage end) for receiving a second power supply voltage ELVSS.

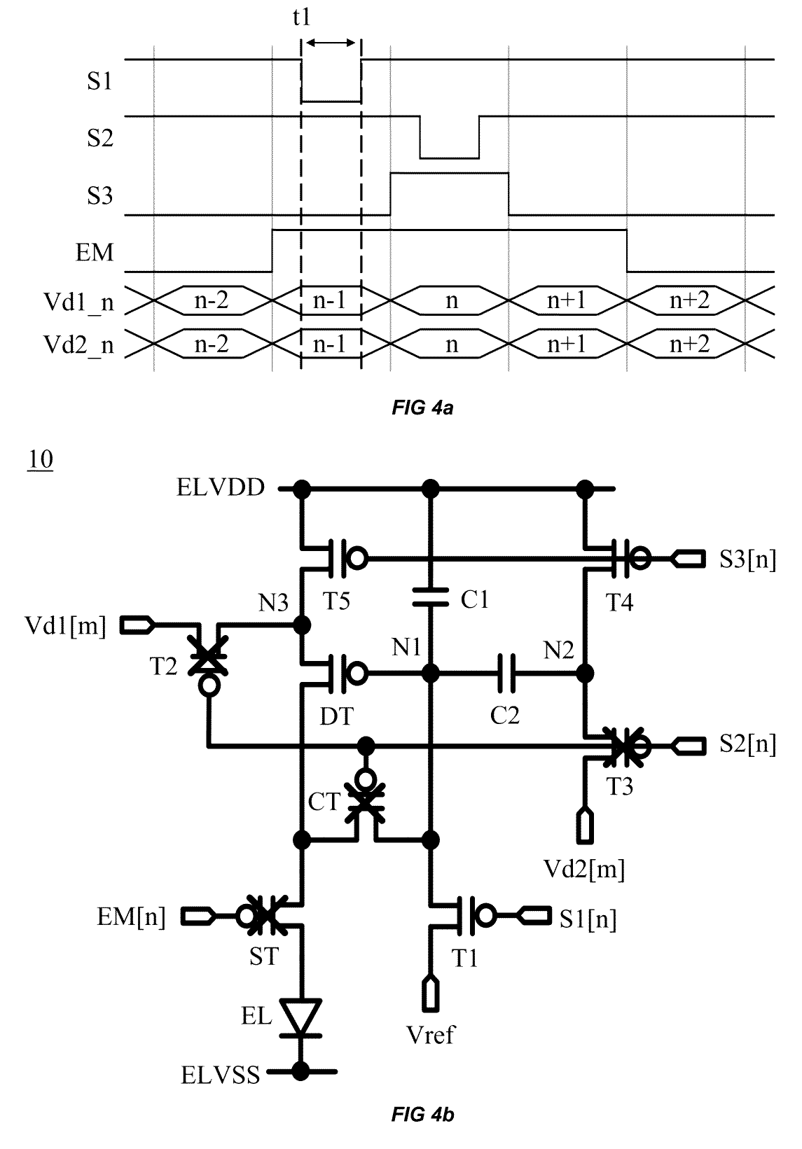

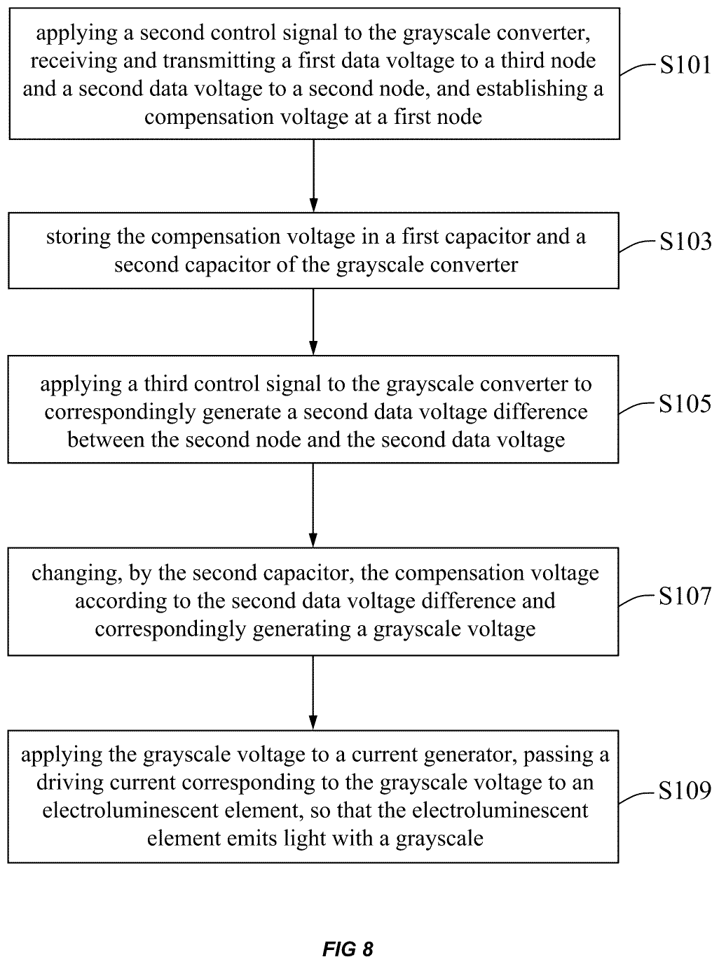

Reference now may be made to FIGS. 3, 4a, 4b and 8. The pixel compensation circuit 10 according to the above embodiment is applicable for adjusting the grayscale of the electroluminescent element EL, and the driving method thereof includes applying a second control signal to a grayscale converter, receiving and transmitting a first data voltage to the third node and a second data voltage to the second node, and establishing a compensation voltage at a first node (S101). Meanwhile, the compensation voltage is stored in the first capacitor and the second capacitor of the grayscale converter (S103).

In an initialization stage, the first control signal S1, the second control signal S2, the third control signal S3, and the light signal EM are set to be negative-edge-triggered. At time T1, the first control signal S1 is pulled to the falling edge, while the second control signal S2, the third control signal S3, and the light emitting signal EM at the high voltage level are not pulled. At this time, the first transistor T1, the fourth transistor T4, the fifth transistor T5, and the driving transistor DT are turned on, while the second transistor T2, the third transistor T3, the compensation transistor CT, and the switching transistor ST are turned off (marked with a “X” symbol in the drawing). The first transistor T1 is turned on in response to the first control signal S1, and receives and transmits the reference voltage Vref to the first node N1 such that the voltage level (referred as V_{N1} hereafter) of the first node N1 is applied as the reference voltage Vref (V_{N1}=Vref) as an initialization voltage for the driving transistor DT to perform initialization setting to the driving transistor DT and wait for a compensation process on its threshold voltage (Vth_{DT}) of the next stage. Meanwhile, since the fourth transistor T4 is turned on, the voltage level (referred as V_{N2} hereafter) of the second node N2 is applied as the first power supply voltage ELVDD (V_{N2}=ELVDD).

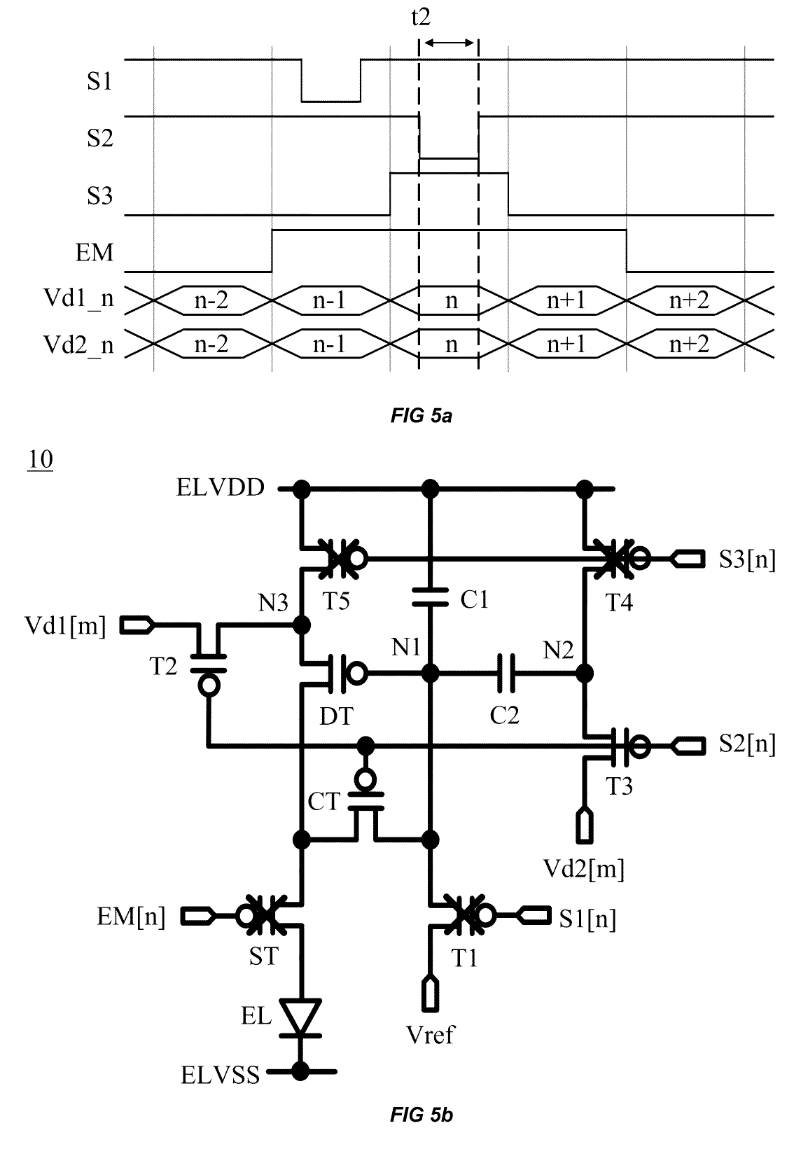

Reference now may be made to FIGS. 3, 5a, 5b, and 8. Next, in a first time period (time T2), the second control signal S2 is pulled to the negative edge, while the first control signal S1, the third control signal S3 and the light emitting signal EM at the high voltage level are not pulled. At this time, the driving transistor DT is kept on and the switching transistor ST is kept off. At the same time, the second transistor T2, the third transistor T3 and the compensation transistor CT are turned on, and the first transistor T1, the fourth transistor T4 and the fifth transistor T5 are turned off. At this time, the second transistor T2 and the third transistor T3 respectively receive and transmit the first data voltage Vd1_n and the second data voltage Vd2_n in response to the second control signal S2, and establish the first data voltage Vd1_n at the third node N3 and the second data voltage Vd2_n at the second node N2 (V_{N2}=Vd2_n), and store the second data voltage Vd2_n in the second capacitor C2. Meanwhile, since the compensation transistor CT is turned on, the first data voltage Vd1_n is applied to the first node N1, and the compensation process is performed on the threshold voltage (Vth_{DT}) of the driving transistor DT with the first data voltage Vd1_n. V_{N1} is changed into a voltage difference between the first data voltage Vd1_n and the threshold voltage of the driving transistor DT, which can be expressed as the following equation.

V_{N1}=Vd1_n−|Vth_{DT}|

Therefore, V_{N1} is changed into a compensation voltage, which may be used as a gate driving voltage (Vg_{DT}) of the driving transistor DT, and is stored by the first capacitor C1 and the second capacitor C2.

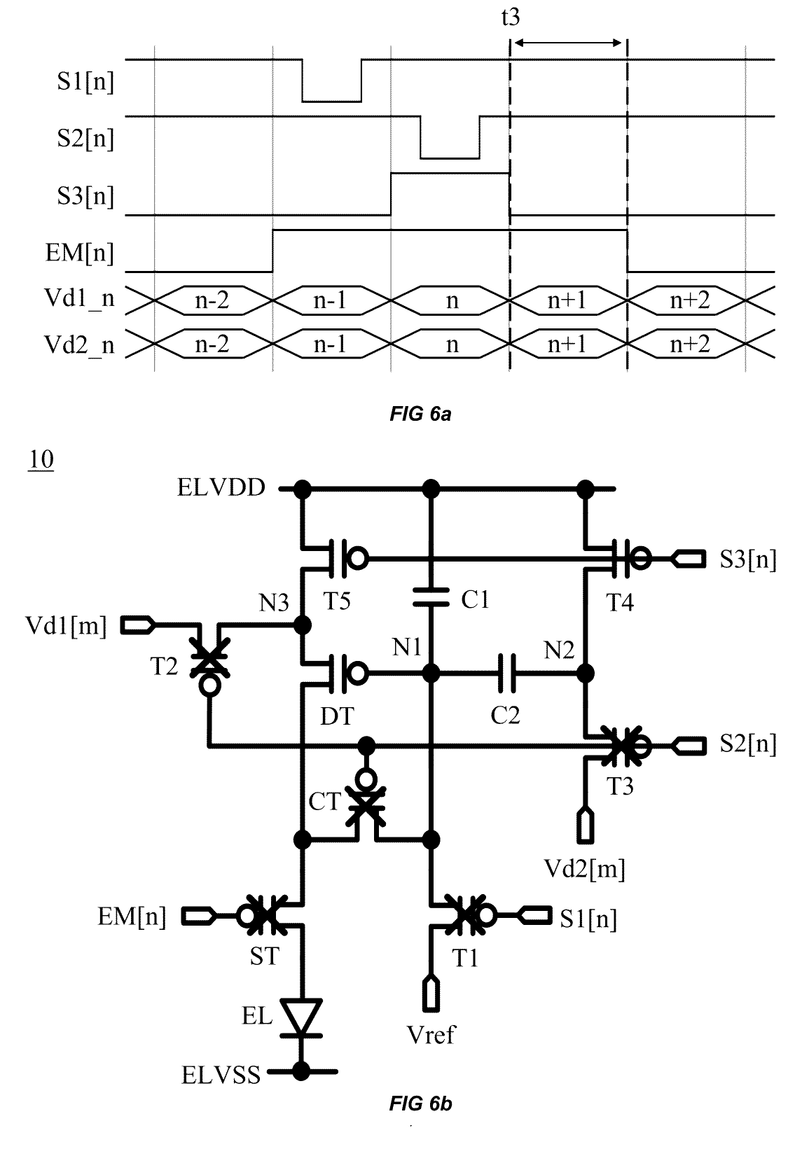

Reference now may be made to FIGS. 3, 6a, 6b and 8. Next, a third control signal is applied to the grayscale converter to correspondingly generate a second data voltage difference between the second node and the second data voltage (S105), and the second capacitor changes the compensation voltage according to the second data voltage difference and correspondingly generates a grayscale voltage (S107).

In a second time period (time T3), the third control signal S3 is pulled to the negative edge, while the first control signal S1, the second control signal S2, and the light signal EM at the high voltage level are not pulled. At this time, the driving transistor DT is kept on, and the switching transistor ST and the first transistor T1 are kept off. Meanwhile, the fourth transistor T4 and the fifth transistor T5 are turned on, and the second transistor T2, the third transistor T3, and the compensation transistor CT are turned off. The fifth transistor T5 is turned on in response to the third control signal S3 and transmits the first power supply voltage ELVDD to the third node N3. Meanwhile, the fourth transistor T4 is turned on in response to the third control signal S3, and transmits the first power supply voltage ELVDD to the second node N2. At this time, the first power supply voltage ELVDD and the second data voltage Vd2_n generate a second data voltage difference (ΔV_{N2}) at the second node N2, so that V_{N2} is changed. Here, the second data voltage difference and the changed V_{N2} can be expressed as the following equations, respectively.

ΔV_{N2}=ELVDD−Vd2_n

V_{N2}=ELVDD=Vd2_n+ΔV_{N2}

Meanwhile, the second data voltage difference is transmitted to the first node N1 through the second capacitor C2, such that V_{N1} is changed from the compensation voltage to a grayscale voltage. V_{N1} at this time can be expressed as the following equation.

V_{N1}=Vd1_n−|Vth_{DT}|+ΔV_{N2}[C2/(C1±C2)]

ΔV_{N2} [C2/(C1+C2)] is the second data division voltage of the second data voltage difference. Therefore, in the embodiment of the present application, the grayscale voltage includes the compensation voltage and the second data division voltage, and the second data division voltage is related to the ratio of the capacitance of the first capacitor C1 to the capacitance of the second capacitor C2.

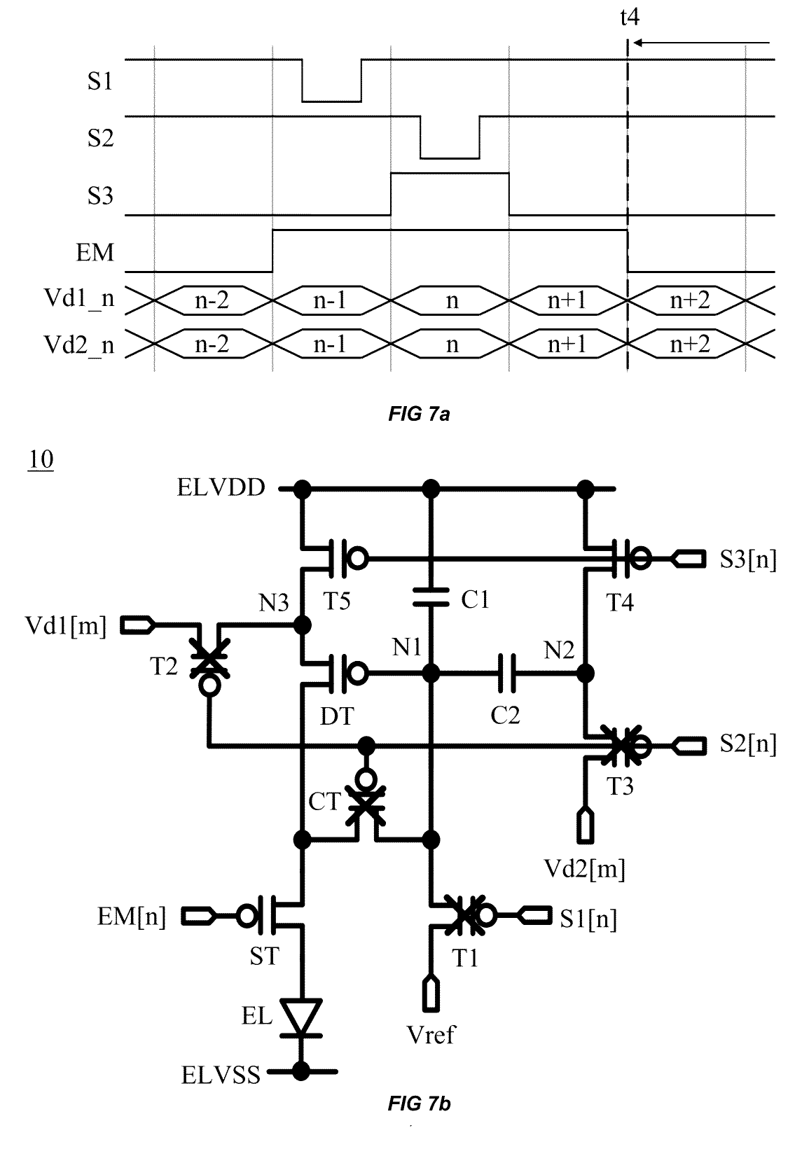

Reference now may be made to FIGS. 3, 7a, 7b, and 8. Then, a grayscale voltage is applied to the current generator to pass a driving current corresponding to the grayscale voltage to the electroluminescent element, so that the electroluminescent element emits light with a grayscale (S109). The grayscale includes a main grayscale and a sub-grayscale, and the sub-grayscale is one of a plurality of sub-grayscales between the main grayscale and a previous grayscale of the main grayscale and between the main grayscale and a next grayscale of the main grayscale.

In a light time period (time T4), the light signal EM is pulled to the negative edge, and the first control signal S1, the second control signal S2, and the third control signal S3 at the high voltage level are not pulled. At this time, the driving transistor DT, the fourth transistor T4, and the fifth transistor T5 are kept on, and the first to third transistors T1 to T3 and the compensation transistor CT are kept off. Meanwhile, the driving transistor DT passes the driving current to the switching transistor ST, and passes the driving current to the electroluminescent element EL when the switching transistor ST is turned on in response to the light signal EM, so that the electroluminescent element EL emits light with a grayscale corresponding to the driving current. At this time, the driving current equivalently output through the switching transistor ST can be expressed as the following equation.

$$\begin{matrix}\vert Id \vert = \frac{1}{2} \times μ \times {C}_{ox} \times {( EL V DD - {V}_{N 1} - \vert {V th}_{DT} \vert )}^{2} \\ = \frac{1}{2} \times μ \times {C}_{ox} \times {( EL V DD - V d1\_n + ( V d 2\_n - EL V DD ) \times \frac{C 2}{C 1 + C 2} )}^{2}\end{matrix}$$

Id is the driving current through the electroluminescent element EL; μ is the mobility; Cox is the gate capacitor; and the term (Vd2_n−ELVDD)*[C2/(C1+C2)] reflects the division of a finer voltage made by voltage division via capacitor.

Therefore, in the embodiment of the present application, the grayscale voltage may be set by the configuration of the first data voltage, the second data voltage, and the first capacitor and the second capacitor connected in parallel. The first data voltage is used for determining a main grayscale voltage, the second data voltage is used as an adjusting voltage of the main grayscale voltage, and finer division may be performed on the main grayscale voltage through voltage division via capacitor, and a sub-grayscale voltage is obtained after the first data voltage and the second data voltage are synthesized, so that the electroluminescent element may emit light with the main grayscale corresponding to the main grayscale voltage or at the sub-grayscale corresponding to the sub-grayscale voltage. The sub-grayscale is one of a plurality of sub-grayscales between a previous grayscale and a next grayscale of the main grayscale on the basis of the main grayscale. Thereby the grayscale of the electroluminescent element may be adjusted in a small data range by adjusting on the first data voltage and the second data voltage, so as to obtain a finer picture closer to the real grayscale.

It can be understood that although in the pixel compensation circuit of the above embodiment, the transistor is exemplified as a p-type TFT or PMOS transistor, in other embodiments of the present disclosure, the pixel circuit maybe implemented with an equivalent circuit in which the fourth transistor may be a p-type TFT or PMOS transistor, and other transistor are n-type TFT or NMOS transistors correspondingly.

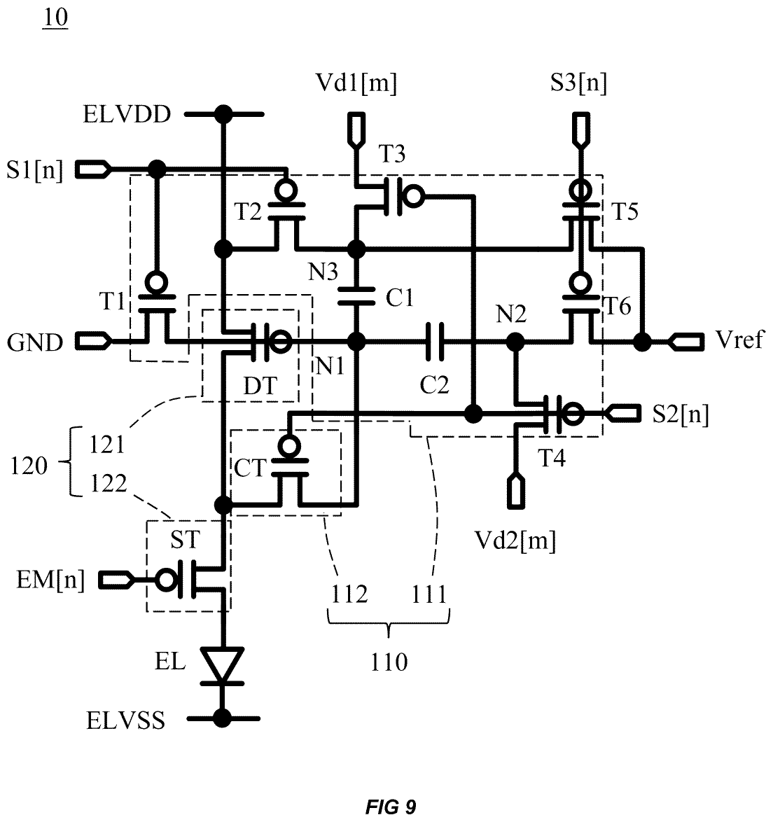

Reference now may be made to FIG. 9, which is a circuit diagram of a pixel compensation circuit according to another embodiment of the present application. In the pixel compensation circuit, the converting circuit 111 of the grayscale converter 110 includes a first capacitor C1, a second capacitor C2, and first transistor T1 to sixth transistor T6.

The first capacitor C1 and the second capacitor C2 are respectively configured to store the compensation voltage in a first time period and change the compensation voltage in a second time period. One terminal of the first capacitor C1 is coupled to a first node N1, and the other terminal is coupled to a third node N3. The second capacitor C2 has one terminal coupled to the first node N1 and the other terminal coupled to the second node N2.

The first transistor T1 has a gate coupled to the first control signal end S1[n] for responding to a first control signal, a first terminal coupled to a first ground end for receiving a ground voltage GND, and a second terminal coupled to the first node N1. The second transistor T2 has a gate coupled to the first control signal end S1[n] for responding to the first control signal, a first terminal coupled to the first power supply for receiving the first power supply voltage ELVDD, and a second terminal coupled to a third node N3. The third transistor T3 has a gate coupled to the second signal line S2[n] for responding to the second control signal, a first terminal coupled to a first data line Vd1[m] for receiving the first data voltage, and a second terminal coupled to the third node N3. The fourth transistor T4 has a gate coupled to a second signal line S2[n] for responding to a second control signal, a first terminal coupled to a second data line Vd2[m] for receiving a second data voltage, and a second terminal coupled to the second node N2. The fifth transistor T5 has a gate coupled to a third signal line S3[n] for responding to a third control signal, a first terminal coupled to a reference voltage end for receiving a reference voltage Vref, and a second terminal coupled to the third node N3. The sixth transistor T6 has a gate coupled to the third signal line S3[n] for responding to the third control signal, a first terminal coupled to the reference voltage end for receiving the reference voltage Vref, and a second terminal coupled to a second node N2.

The compensation circuit 112 of the grayscale converter 110 includes a compensation transistor CT having a gate coupled to the second signal line S2[n] for responding to the second control signal, a first terminal coupled between the driving circuit 121 of the current generator 120 and the switching circuit 122, and a second terminal coupled to the first node N1.

In addition, the driving circuit 121 of the current generator 120 includes a driving transistor DT having a gate coupled to the first node N1, a first terminal coupled to the second transistor T2 and the first power supply, and a second terminal coupled to the compensation transistor CT and the switching circuit 122. The switching circuit 122 of the current generator 120 includes a switching transistor ST having a gate coupled to the light signal end EM [n] for responding to a light signal, a first terminal coupled to the second terminal of the driving transistor DT, and a second terminal coupled to an anode of the electroluminescent element EL. A cathode of the electroluminescent element EL is coupled to a second power supply (second power supply voltage end) for receiving a second power supply voltage ELVSS.

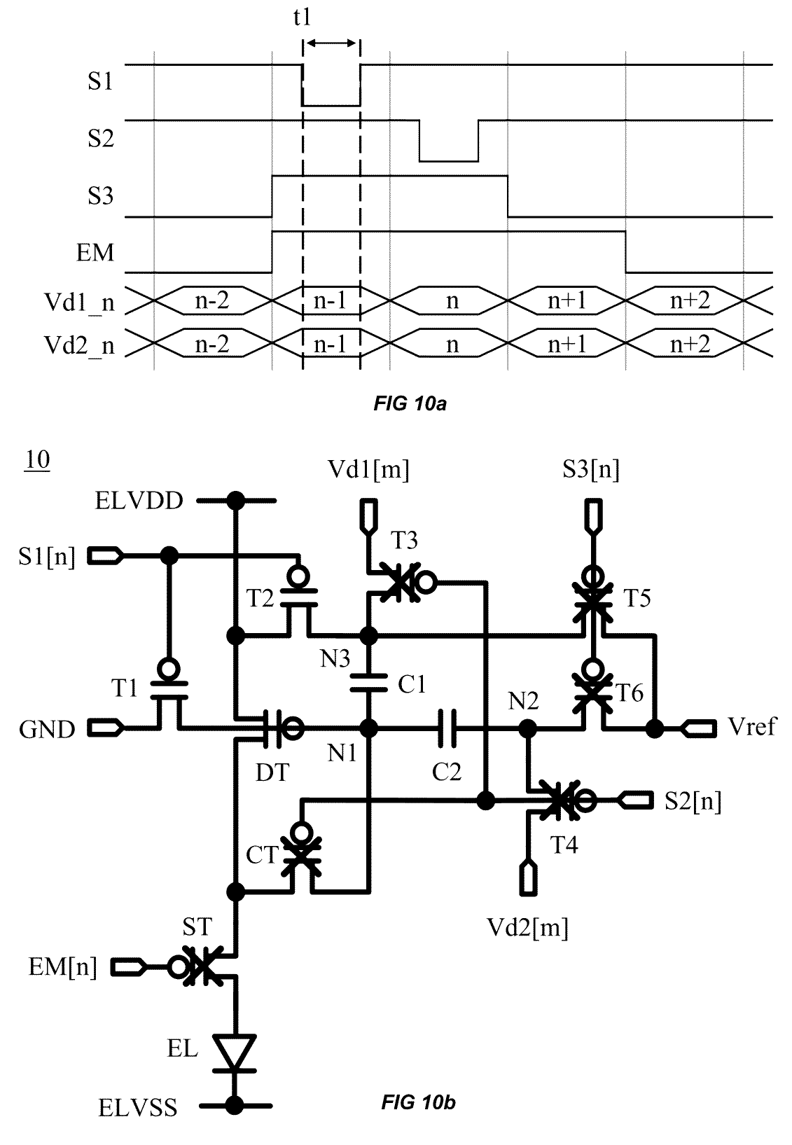

Reference now may be made to FIGS. 9 to 10b. The pixel compensation circuit 10 of the present embodiment is applicable for adjusting the grayscale of the electroluminescent element EL. In an initialization stage, the first control signal S1, the second control signal S2, the third control signal S3, and the light signal EM are set to be negative-edge-triggered. At time T1, the first control signal S1 is pulled to the falling edge, while the second control signal S2, the third control signal S3, and the light signal EM at the high voltage level are not pulled. At this time, the first transistor T1, the second transistor T2, and the driving transistor DT are turned on, while the third to sixth transistors T2 to T6 and the compensation transistor CT and the switching transistor ST are turned off (marked with a “X” symbol in the drawing). The first transistor T1 is turned on in response to the first control signal S1 to transmit the ground voltage GND to the first node N1, such that the voltage level at the first node N1 is applied with the ground voltage GND (V_{N1}=GND) as the initialization voltage of the driving transistor DT, so as to perform initialization setting on the driving transistor DT and waits for a compensation process of the next stage on the threshold voltage (Vth_{DT}). Meanwhile, the second transistor T2 is turned on in response to the first control signal S1 and passes the first power supply voltage ELVDD to the third node N3, such that the voltage level (referred as V_{N2} hereafter) of the third node N3 is applied with the first power supply voltage ELVDD (V_{N3}=ELVDD) to perform initialization setting on the first capacitor C1.

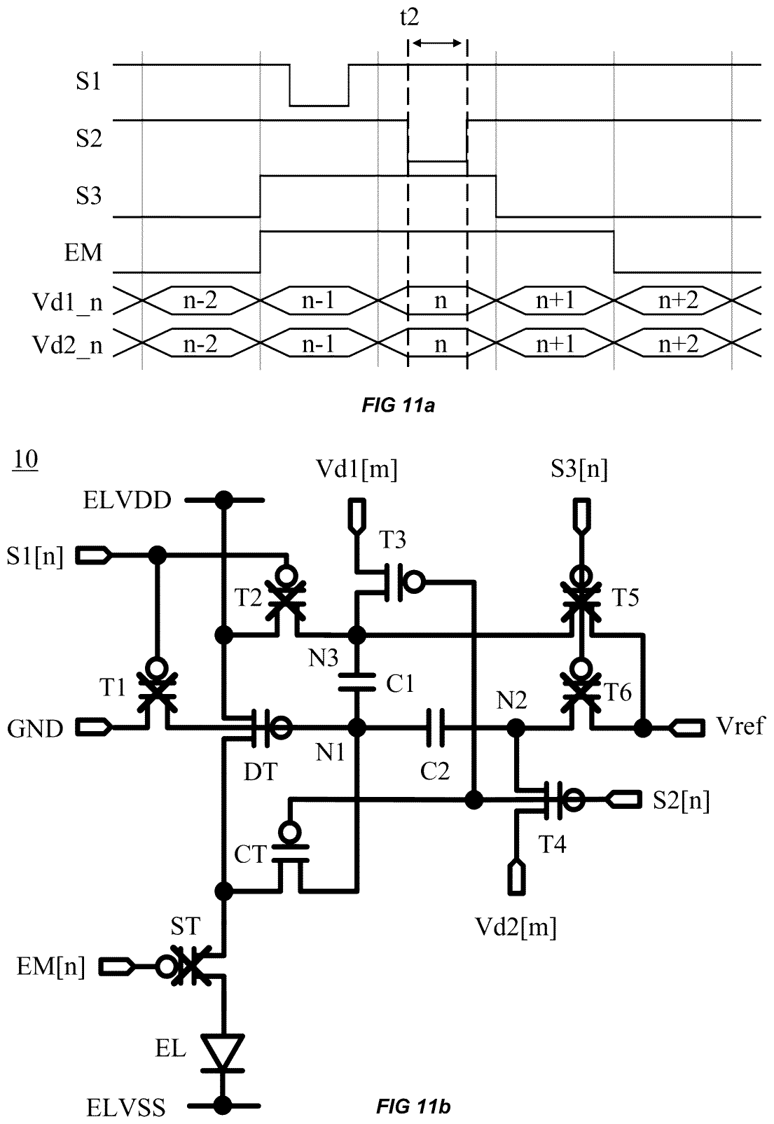

Reference now may be made to FIGS. 9, 11a, and 11b. Then, in a first time period (time T2), the second control signal S2 is pulled to the negative edge, while the first control signal S1, the third control signal S3 and the light signal EM at the high voltage level are not pulled. At this time, the driving transistor DT is kept on, and the switching transistor ST, the fifth transistor T5, and the sixth transistor T6 are kept off. Meanwhile, the third transistor T3, the fourth transistor T4, and the compensation transistor CT are turned on, and the first transistor T1 and the second transistor T2 are turned off.

The third transistor T3 is turned on in response to the second control signal S2, and receives and transmits the first data voltage Vd1_n to the third node N3 to establish the first data voltage Vd1_n at the third node N3 (V_{N3}=Vd1_n), and stores the first data voltage Vd1_n into the first capacitor C1. Meanwhile, the fourth transistor T4 is turned on in response to the second control signal S4, and receives and transmits the second data voltage Vd2_n to the second node N2 to establish the second data voltage Vd2_n at the second node N2 (V_{N2}=Vd2_n) and store the second data voltage Vd2_n into the second capacitor C2. Since the compensation transistor CT is turned on, the first power supply voltage ELVDD is applied to the first node N1 to perform compensation process on the threshold voltage (Vth_{DT}) of the driving transistor DT with the first power supply voltage ELVDD. V_{N1} is changed in to the voltage difference between the first power supply voltage ELVDD and the threshold voltage of the driving transistor DT, which can be expressed as the following equation.

V_{N1}=ELVDD−|Vth_{DT}|

Therefore, V_{N1} is changed into a compensation voltage, which may be used as a gate driving voltage (Vg_{DT}) of the driving transistor DT, and is stored by the first capacitor C1 and the second capacitor C2.

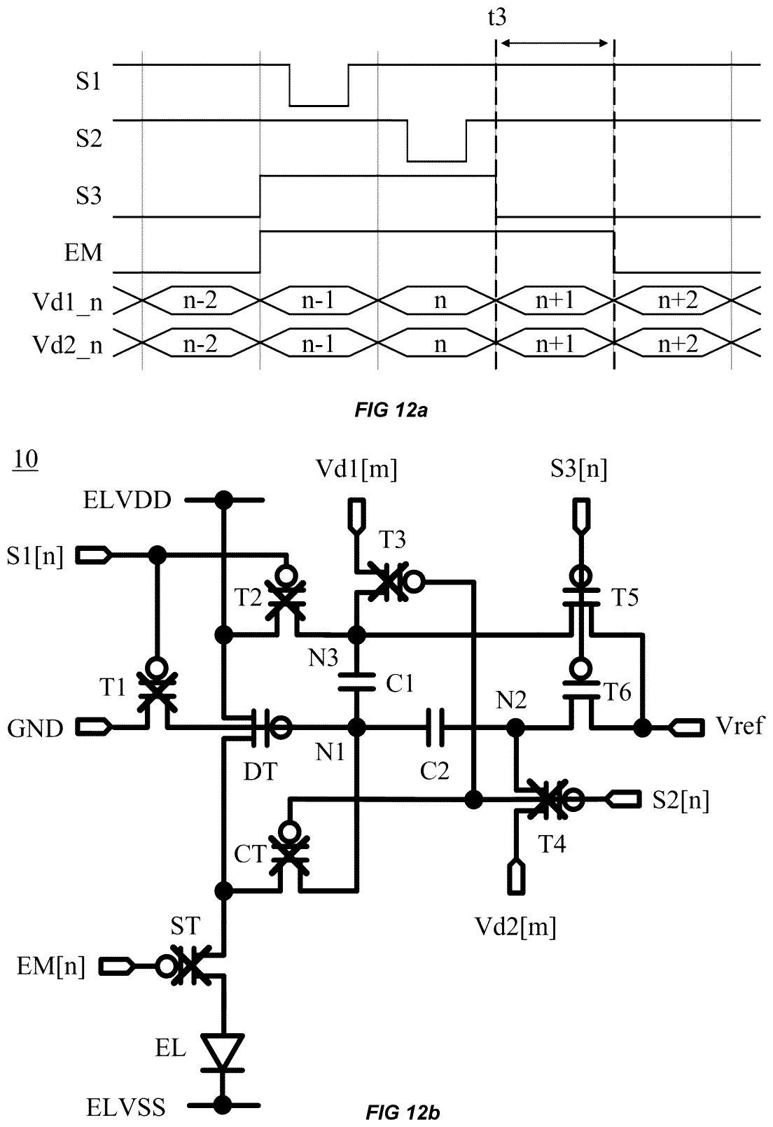

Reference now may be made to FIGS. 9, 12a and 12b. In a second time period (time T3), the third control signal S3 is pulled to the negative edge, while the first control signal S1, the second control signal S2, and the light signal EM at the high voltage level are not pulled. At this time, the driving transistor DT is kept on, and the switching transistor ST, the first transistor T1, and the second transistor T2 are kept off. At the same time, the fifth transistor T5 and the sixth transistor T6 are turned on, and the third transistor T3, the fourth transistor T4, and the compensation transistor CT are turned off. The fifth transistor T5 is turned on in response to the third control signal S3 to transmit the reference voltage Vref to the third node N3, such that V_{N3} is changed to the reference voltage Vref (V_{N3}=Vref) and a first data voltage difference (ΔV_{N3}) is generated at the third node N3. Meanwhile, the sixth transistor T6 is turned on in response to the third control signal S3, to transmit the reference voltage Vref to the second node N2, such that V_{N2} is changed into the reference voltage Vref (V_{N2}=Vref) and a second data voltage difference (ΔV_{N2}) is generated at the second node N2.

Here, the first data voltage difference and the first data voltage difference may be expressed as the following equations, respectively.

ΔV_{N3}=Vref−Vd1_n

ΔV_{N2}=Vref−Vd2_n

Meanwhile, the first data voltage difference is transmitted to the first node N1 by the first capacitor C1, and the second data voltage difference is transmitted to the first node N1 by the second capacitor C2, such that V_{N1} is changed from the compensation voltage to a grayscale voltage. V_{N1} at this time can be expressed as the following equation.

V_{N1}=ELVDD−|Vth_{DT}|+ΔV_{N3}[C1/(C1+C2)]+ΔV_{N2}[C2/(C1+C2)]

ΔV_{N3}[C1/(C1+C2)] is a first data division voltage of the first data voltage difference, and ΔV_{N2}[C2/(C1+C2)] is a second data division voltage of the second data voltage difference. Therefore, in the embodiment of the present application, the grayscale voltage includes the compensation voltage, the first data division voltage and the second data division voltage, and both of the first data division voltage and the second data division voltage are related to a ratio of a capacitance of the first capacitor C1 to a capacitance of the second capacitor C2.

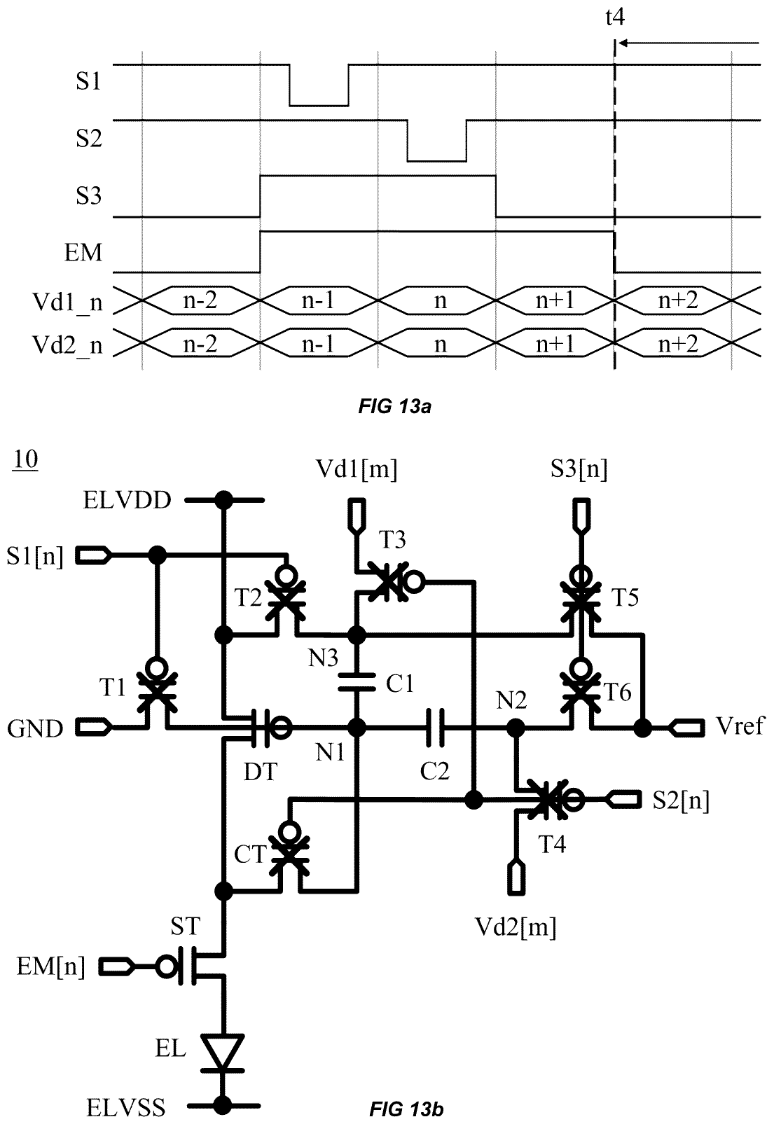

Reference now may be made to FIGS. 9, 13a and 13b. Then, in a light time period (time T4), the light signal EM is pulled to the negative edge, and the first control signal S1, the second control signal S2, and the third control signal S3 at the high voltage level are not pulled. At this time, the driving transistor DT is kept on, the first to fourth transistors T1 to T4 and the compensation transistor CT are kept off, and the fifth and sixth transistors T5 and T6 are turned off. At this time, the switching transistor ST is turned on in response to the light signal EM, and passes the driving current to the electroluminescent element EL, so that the electroluminescent element EL emits light with a grayscale corresponding to the driving current. Here, the driving current equivalently output through the switching transistor ST may be expressed as the following equation.

$$\begin{matrix}\vert Id \vert = \frac{1}{2} \times μ \times {C}_{ox} \times {( EL V DD - {V}_{N 1} - \vert {V th}_{DT} \vert )}^{2} \\ = \frac{1}{2} \times μ \times {C}_{ox} \times {( - Δ {V}_{N 3} \times \frac{C 1}{C 1 + C 2} - {Δ V}_{N 2} \times \frac{C 2}{C 1 + C 2} )}^{2}\end{matrix}$$

Id is the driving current through the electroluminescent element EL; μ is the mobility; Cox is the gate capacitor; term −ΔVN3*[C1/(C1+C2)] reflects the main voltage and the term (Vd2_n−ELVDD)*[C2/(C1+C2)] reflects the division of a finer voltage that is made.

Therefore, in the embodiments of the present application, the main grayscale voltage may be determined by the first data voltage, the sub-grayscale voltage may be determined by the second data voltage, and a finer division on voltage is performed by a capacitor, so as to control the grayscale of the electroluminescent element in a small data range, so as to obtain a fine picture closer to the real grayscale.

Characteristics of various embodiments summarized above are for better understanding of one skilled in the art on the present disclosure. One skilled in the art should understand that the present disclosure is convenient to be used as a basis of designing or modifying other processes and structures to implement the embodiments described in the present disclosure for same objects and/or achieve same advantages. One skilled in the art should also understand that such equivalent constructions are within the spirit and scope of the present disclosure, and various variations, modifications, alternatives can be made thereto without departing from the spirit and scope of the present disclosure.

1. A pixel compensation circuit, comprising:
an electroluminescent element;
a grayscale converter, coupled to a first node and at least one data terminal, and configured to receive a first data voltage and a second data voltage, establish a compensation voltage at the first node in a first time period, and change the compensation voltage to a grayscale voltage according to the first data voltage and the second data voltage in a second time period, wherein the grayscale voltage comprises a main grayscale voltage corresponding to the first data voltage and a sub-grayscale voltage synthesizing the first data voltage and the second data voltage, and
a current generator, coupled to the first node and the grayscale converter, and configured to pass a driving current in response to the grayscale voltage and transmit the driving current to the electroluminescent element in response to a light signal, so as to drive the electroluminescent element to emit light with a grayscale;
wherein the grayscale comprises a main grayscale and a sub-grayscale corresponding to the grayscale voltage, and the sub-grayscale is one of a plurality of sub-grayscales between the main grayscale and a previous grayscale of the main grayscale and between the main grayscale and a next grayscale of the main grayscale.

2. The pixel compensation circuit according to claim 1, wherein the current generator comprises a driving transistor and a switching transistor, two opposite terminals of the driving transistor are respectively coupled to a first power supply and the switching transistor, and a gate of the driving transistor is coupled to the first node and configured to be turned on in response to the grayscale voltage, so as to pass the driving current to the switching transistor, two opposite terminals of the switching transistor are respectively coupled to the driving transistor and the electroluminescent element, and a gate of the switching transistor is coupled to a light signal end and configured to be turned on in response to a light signal so as to pass the driving current to the electroluminescent element.

3. The pixel compensation circuit according to claim 2, wherein the grayscale converter comprises a compensation circuit, a compensation transistor of the compensation circuit is coupled to the driving transistor, the switch transistor, and the first node, and configured to be turned on in response to a second control signal, and correspondingly establish the compensation voltage at the first node.

4. The pixel compensation circuit according to claim 3, wherein the grayscale converter further comprises a converting circuit configured to establish the first data voltage at a third node and the second data voltage at a second node in response to the second control signal.

5. The pixel compensation circuit according to claim 4, wherein the converting circuit comprises a first capacitor and a second capacitor, respectively configured to store the compensation voltage in the first time period and change the compensation voltage in the second time period, wherein one terminal of the first capacitor is coupled to the first node, and the other terminal of the first capacitor is coupled to the first power supply or the third node, one terminal of the second capacitor is coupled to the first node, and the other terminal of the second capacitor is coupled to the second node.

6. The pixel compensation circuit according to claim 5, wherein two opposite terminals of the first capacitor are coupled to the first node and the first power supply, the compensation transistor is turned on in response to the second control signal and transmits the first data voltage to the first node, the compensation voltage is a voltage difference between the first data voltage and a threshold voltage of the driving transistor.

7. The pixel compensation circuit according to claim 6, wherein the converting circuit further comprises:
a first transistor, respectively coupled to a reference voltage end and the first node, and configured to transmit a reference voltage to the first node in response to a first control signal as an initialization voltage of the driving transistor;
a second transistor, respectively coupled to a first data end and the third node, and configured to transmit the first data voltage to the third node in response to the second control signal;
a third transistor, respectively coupled to a second data end and the second node, and configured to transmit the second data voltage to the second node in response to the second control signal;
a fourth transistor, respectively coupled to the first power supply and the second node, and configured to transmit the first power supply voltage to the second node in response to a third control signal, and generate a second data voltage difference between the second node and the second data voltage;
a fifth transistor, respectively coupled to the first power and the third node, and configured to transmit the first power supply voltage to the third node in response to the third control signal, wherein the third node is coupled to the second transistor, the fifth transistor and the driving transistor.

8. The pixel compensation circuit according to claim 5, wherein two opposite terminals of the first capacitor are coupled to the first node and the third node, the compensation transistor is turned on in response to the second control signal and receives and transmits a first power supply voltage to the first node, the compensation voltage is a voltage difference between the first power supply voltage and a threshold voltage of the driving transistor.

9. The pixel compensation circuit according to claim 8, wherein the converting circuit further comprises:
a first transistor, respectively coupled to a ground terminal and the first node, and configured to transmit a ground voltage to the first node in response to a first control signal as an initialization voltage of the first capacitor;
a second transistor, respectively coupled to the first power supply and the third node, and configured to transmit a first power supply voltage to the third node in response to the first control signal;
a third transistor, respectively coupled to a first data terminal and the third node, and configured to transmit the first data voltage to the third node in response to the second control signal;
a fourth transistor, respectively coupled to a second data end and the second node, and configured to transmit the second data voltage to the second node in response to the second control signal;
a fifth transistor, respectively coupled to a reference voltage end and the third node, and configured to transmit a reference voltage to the third node in response to a third control signal and generate a first data voltage difference between the first data voltage and the reference voltage at the third node;
a sixth transistor, respectively coupled to the reference voltage end and the second node, and configured to transmit the reference voltage to the second node in response to the third control signal and generate a second data voltage difference between the second node and the second data voltage.

10. An electroluminescence display, comprising:
an array of pixel cells, wherein each pixel cell comprises the pixel compensation circuit according to claim 1.

11. A driving method for driving a pixel compensation circuit, comprising:
applying a second control signal to the grayscale converter, receiving and transmitting a first data voltage to a third node and a second data voltage to a second node, and establishing a compensation voltage at a first node;
storing the compensation voltage in a first capacitor and a second capacitor of the grayscale converter;
applying a third control signal to the grayscale converter to correspondingly generate a second data voltage difference between the second node and the second data voltage;
changing, by the second capacitor, the compensation voltage according to the second data voltage difference and correspondingly generating a grayscale voltage, wherein the grayscale voltage comprises the compensation voltage and a second data division voltage of the second data voltage difference, and the second data division voltage is related to a ratio of a capacitance of the first capacitor to a capacitance of the second capacitor; and
applying the grayscale voltage to a current generator, passing a driving current corresponding to the grayscale voltage to an electroluminescent element, so that the electroluminescent element emits light with a grayscale, wherein the grayscale comprises a main grayscale and a sub-grayscale, and the sub-grayscale is one of a plurality of sub-grayscales between the main grayscale and a previous grayscale of the main grayscale and between the main grayscale and a next grayscale of the main grayscale.

12. The driving method according to claim 11, wherein the step of applying a second control signal to the grayscale converter further comprises:
receiving and transmitting, by a converting circuit of the grayscale converter, the first data voltage to the third node and the second data voltage to the second node in response to the second control signal; and
establishing, by a compensation circuit of the grayscale converter, the compensation voltage at the first node in response to the second control signal.

13. The driving method according to claim 12, wherein the step of applying a third control signal to the grayscale converter further comprises:
receiving and transmitting, by the converting circuit, a first power supply voltage or a reference voltage to the second node in response to the third control signal, and generating the second data voltage difference between the first power supply voltage or the reference voltage and the second data voltage.

14. The driving method according to claim 13, further comprising:
generating, by the switching circuit, a first data voltage difference at the third node in response to the third control signal; and
changing, by the first capacitor, the compensation voltage according to the first data voltage difference synchronously to generate the grayscale voltage, wherein the grayscale voltage comprises the compensation voltage, the second data division voltage, and a first data division voltage of the first data voltage difference, and the first data division voltage is related to a ratio of a capacitance of the first capacitor to a capacitance of the second capacitor.

15. The driving method according to claim 11, wherein the step of applying the grayscale voltage to a current generator further comprises:
applying the grayscale voltage to a driving transistor of the current generator and passing the driving current to a switching transistor of the current generator; and
applying a light signal to the switching transistor to pass the driving current to the electroluminescent element.

16. The driving method according to claim 15, wherein before the step of applying a second control signal to the grayscale converter, the driving method further comprises:
applying a first control signal to the grayscale converter, passing a reference voltage to the first node, and initializing a gate of the driving transistor; or
passing a ground voltage to the first node to initialize the gate of the driving transistor, and passing a first power supply voltage to the third node to initialize one terminal of the first capacitor, wherein two opposite terminals of the first capacitor are coupled to the first node and the third node, respectively.

17. An electroluminescence display, comprising:
an array of pixel cells, wherein each pixel cell comprises the pixel compensation circuit according to claim 2.

18. An electroluminescence display, comprising:
an array of pixel cells, wherein each pixel cell comprises the pixel compensation circuit according to claim 3.

19. An electroluminescence display, comprising:
an array of pixel cells, wherein each pixel cell comprises the pixel compensation circuit according to claim 4.

20. An electroluminescence display, comprising:
an array of pixel cells, wherein each pixel cell comprises the pixel compensation circuit according to claim 5.
